(19) United States
(12) Patent Application Publication
(10) Pub. No.: US 2008/0005525 A1
(43) Pub. Date: Jan. 3, 2008

(54) Partitioning program memory

(76) Inventors: Mark B. Rosenbluth, Uxbridge, MA (US); Jose S. Niell, Franklin, MA (US); Steve Zagorianakos, Brookline, NH (US)

Correspondence Address: Gossman, Tucker, Perreault & Pfleger, PLLC;c/o Intellevate, P.O. Box 52050, Minneapolis, MN, 55402, US

(21) Appl. No.: 11/478,106

(22) Filed: Jun. 29, 2006

(51) Int. Cl. G06F 12/00

(52) U.S. Cl. 711/173

(57) ABSTRACT

A method according to one embodiment may include partitioning a memory into a first partition and a second partition; storing instructions in the first partition; providing access, by at least one thread among a plurality of threads, to instructions in the first partition; dividing the second partition into a plurality of segments; storing instructions in each respective segment corresponding to each respective thread; and providing access to each respective segment for each respective thread. Of course, many alternatives, variations, and modifications are possible without departing from this embodiment.

### FIELD

The present disclosure relates to partitioning program memory.

### BACKGROUND

Processors may use multiple threads to process data. A processor may include program instruction memory to temporarily store small program images, and each thread may access the program memory to fetch these small program images during data processing. The program images may be stored in a larger memory (e.g., memory external to the processor) and copied into the program memory as needed. In a multi-threaded environment, each thread (context) may use all or part of the program memory to execute code specific to the task being executed by the thread. As threads are “swapped out”, the program memory may be refreshed with additional instructions copied from the larger memory into the program memory.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating one exemplary embodiment;

FIG. 2 is a diagram illustrating in more detail the program memory of FIG. 1 in relation to a larger memory;

FIG. 3 is a diagram illustrating an exemplary program memory address generated by the program memory partitioning circuitry of FIG. 1;

FIG. 4 is a diagram illustrating one exemplary integrated circuit embodiment;

FIG. 5 is a diagram illustrating one exemplary system embodiment;

FIG. 6 depicts a flowchart of operations according to one embodiment; and

FIG. 7 depicts a flowchart of operations according to another embodiment.

Although the following Detailed Description will proceed with reference being made to illustrative embodiments, many alternatives, modifications, and variations thereof will be apparent to those skilled in the art.

### DETAILED DESCRIPTION

Network devices may utilize multiple threads to process data packets. These threads may use program counters to address instructions stored in program memory. The program memory may be a small, fixed resource that temporarily stores small program images. A larger pool of instructions may be stored in another, larger memory and copied into the program memory on a per-thread basis. For example, in some network devices, the program memory may be only 8k addressable, while the larger memory may be 128k, or more. At any given time, a thread's program counter may be active and used to fetch instructions stored in the program memory. As a thread requires more instructions, it may generate a copy request to the larger memory to copy instructions into the program memory.

In some conventional network devices, the program memory can be reloaded by forcing all threads to stop executing, and then instructions may be copied from the larger memory into the program memory. Yet other network devices permit “on-the-fly” reloading of the program memory from the larger memory while permitting other thread(s) to continue executing instructions. However, such “on-the-fly” processing may present problems. Each thread may be executing instructions independently of other threads, and thus each thread may be “unaware” of what part of the instructions may have been loaded into the program memory. For example, one thread could replace instructions that another thread needs to execute. Continual displacement of instructions, with little or no forward progress in execution, is known as “thrashing”.

Generally, this disclosure describes program memory that may be partitioned to provide access to instructions on a per-thread basis. For example, in a processing environment where eight threads execute instructions, an 8k program memory may be partitioned into a first 4k partition (e.g., 0-4k) and a second 4k partition (e.g., 4k-8k). The first partition may provide a common memory space to store instructions that are used frequently by two or more threads. The second partition may be further divided into 8 segments of 512 instructions per segment. Each segment may provide a dedicated memory space for each respective thread. Further, each segment may be accessed and reloaded frequently by respective threads (which may occur independently of other threads). By storing frequently-used instructions in the first partition, copy operations from a larger memory into the program memory may be reduced. Additionally, by segmenting the second partition to provide each thread its own program memory space, the possibility that other threads may displace instructions used by a given thread may be eliminated. Accordingly, efficiency of memory operations may be improved.

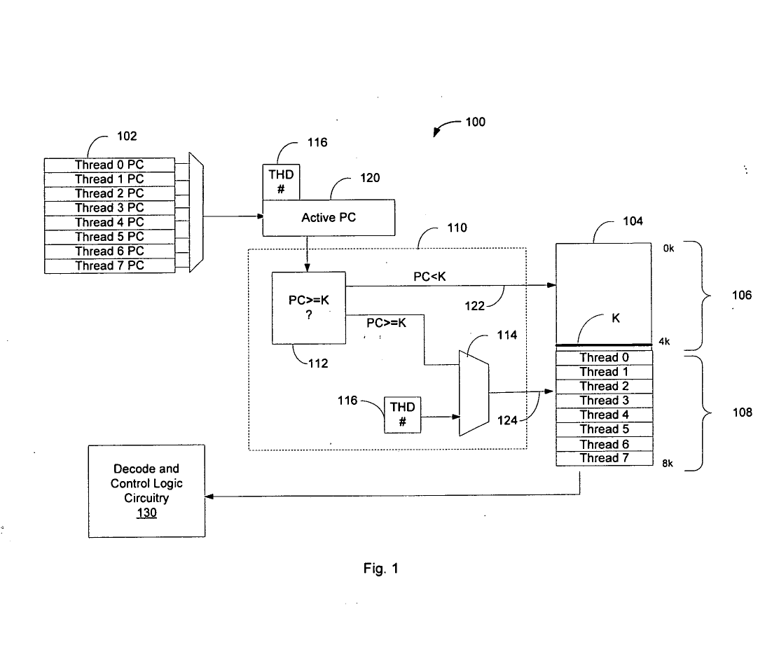

FIG. 1 illustrates one exemplary embodiment 100. The embodiment of FIG. 1 represents a simplified address path of a plurality of threads to address a program memory. Accordingly, this embodiment may include a plurality of threads 102, represented by a plurality of respective program counters (PC), e.g., Thread 0 PC, Thread 1 PC, . . . , Thread 7 PC, which may be used to access a program memory 104. Each respective PC may define an address to fetch instructions stored in the program memory 104. In this embodiment, the program memory 104 may be partitioned into a first partition 106 and a second partition 108. The second partition 108 may be divided into a plurality of segments, denoted by Thread 0, Thread 1, . . . , Thread 7 in FIG. 1. Each segment may define a separate memory space for storing instructions for each respective thread, e.g., memory space for Thread 1, memory space for Thread 2, etc. The first partition 106 may store instructions that are shared by two or more threads. Each segment of the second partition 108 may define a dedicated memory space for each respective thread.

In this example, eight threads (Thread 0, Thread 1, . . . , Thread 7) may be utilized, although a greater or fewer number of threads may be used without departing from this embodiment. Also, in this example, the program memory 104 is an 8k memory space, the first partition 106 is 4k of addressable memory space defined greater than or equal to Ok and less than 4k. The second partition 108 is also 4k of addressable memory space defined greater than or equal to 4k and less than 8k. Each segment of the second partition may be 512 instructions of addressable memory space, defined in sequence in the second partition 108. The address that divides the first partition 106 from the second partition 108 is referred to herein as K, and in this example is at address 4k. Of course, these are arbitrary values and are used in this embodiment for exemplary purposes only, and thus, the present embodiment may be used for program memory of any size and the partitions and segments may be defined to have any size and at any location within the program memory 104.

The first partition 106 may store instructions that are addressed by at least one thread via at least one program counter. In one example, the first partition 106 may store commonly-used and/or frequently-used instructions. For example, primary branch instructions (that may be accessed frequently by two or more threads) may be stored in the first partition 106. Such instructions may not require frequent replacement, since these types of instructions may be repeatedly used by two or more threads. Instructions stored in the second partition 108 may be frequently swapped out for other instructions, for example, secondary branch instructions which may be executed and then replaced with other secondary branch instructions. In general, the instructions stored in both the first and second partitions of the program memory 104 may be copied from a different, larger memory. For example, selected instructions may be copied into the first partition 106, and, during operation, each thread may generate a copy request to copy instructions from the larger memory into respective segments of the second partition 108.

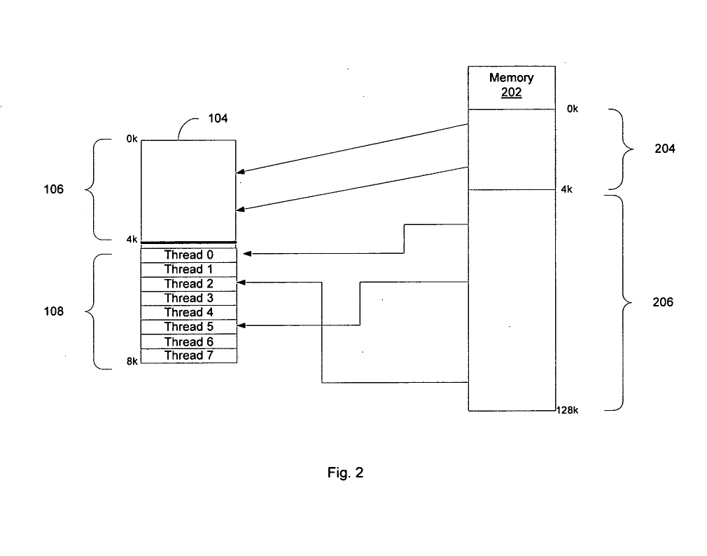

For example, FIG. 2 depicts the program memory 104 in relation to a larger memory 202. Instructions may be copied from the larger memory 202 into the program memory 104. In one embodiment, frequently used and/or commonly used instructions may be stored in a first portion 204 of the larger memory and copied directly into the first partition 106 of the program memory 104. To that end, instructions may be compiled and stored in the first portion 204 of the larger memory 202 in advance to permit direct copying of instructions between memory space 204 and 106. Instructions that may be used on a per-thread basis may be stored in a second portion 206 of the larger memory 202. Each thread may copy instructions into respective segments of the second partition 108 of the program memory 104. In this example, the larger memory 202 may be 128k addressable (17-bit address). As instructions are copied from the larger memory 202 into the program memory 104, an address corresponding to the memory location in the larger memory 202 may be supplied as a program counter (PC) for each thread.

Referring again to FIG. 1, as a thread becomes active, that thread's PC 102 may be copied into the active PC 120 so that it may be used to fetch instructions from the program memory 104 (this operation may assume that the instructions to be fetched from program memory 104 may have already been copied from the larger memory 202). The thread number 116 may correspond to the thread that is active. As stated, the active PC 120 may have an address that corresponds to the larger memory 202. In this example, the active PC 120 may have a 17 bit address. However, in this example, the program memory 104 may have a 13-bit addressable memory space (8k). Accordingly, this embodiment may also include program memory access circuitry 110 to provide a given thread access to the program memory 104, and in particular to provide access to the first partition 106 and/or a segment of the second partition 108, based on, at least in part, an active PC address 120 that corresponds to an address in a larger memory and the thread number 116 making the instruction fetch request.

As an overview, program memory access circuitry 110 may include decision circuitry 112 and decoder circuitry 114. The decision circuitry 112 may be configured to determine if the active PC 120 is greater than or equal to the address defined by K, or if the active PC 120 is less than the address defined by K. In other words, the decision circuitry 112 may be configured to compare the address of the active PC 120 to K to determine if the active PC address 120 is for addressing instructions stored in the first partition 106 or the second partition 108. If the active PC 120 defines an address for instructions stored in the first partition 106 (e.g., active PC<K), the decision circuitry may generate a first address 122 to address instructions stored in the first partition 106 of the program memory 104. If the active PC 120 defines an address for instructions stored in the second partition 108 (e.g., active PC>=K), the decoder circuitry 114 may generate a second address 124 to address instructions stored in one of the segments of the second partition 108 of the program memory, based on, at least in part, the thread number 116 associated with the active PC 120 and the address of K. Once the instructions are addressed in program memory 104, the instructions may be passed to decode and control logic circuitry 130 for processing.

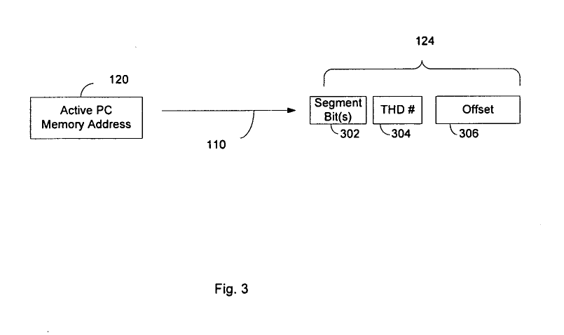

FIG. 3 is a diagram illustrating an exemplary program memory address generated by the program memory access circuitry 110 of FIG. 1. Address 124 may include one or more segment bits 302, the binary value of the thread number 304, and an offset 306. As set forth above, the address 120 may be addressing a larger memory than address 124, and thus, address 120 may include a greater number of bits than address 124. As such, access circuitry 110 may truncate address 120 and manipulate the remaining bits in the address to generate address 124, as described below.

Access circuitry 110 may generate one or more segment bits 302 as the most significant bit(s) (MSB) of the address 124 if the active PC address 120 is addressing a location in the second partition 108 of the program memory 104 (FIG. 1). These segment bits may be generated so that the address 124 is in the second partition 108. The binary value of the thread number 304 may follow the segment bit(s) 302. This may operate to place the address 124 in the appropriate thread-specific portion of the second partition 108 of the program memory 104. The offset 306 may include the least significant bits (LSBs) of the active PC address 120. The offset 306 may operate to place the address 124 at a specific memory address within thread-specific portion of the second partition 108 of the program memory 104. The following is a numeric example of exemplary operations of access circuitry 110.

In this example, assume K=4k, the program memory 104 is 8k of addressable memory space (13 bit address) and the active PC 120 is a 17 bit address. Also, assume for this example that the active thread number 116 is Thread 5, represented by the binary sequence 101, and the active PC 120 address is represented by the binary sequence 1_{—}0111_{—}0100_{—}1111_{—}0001. Thus, in this example, there is a 4-bit difference between the active PC 120 address (17 bit) and the address for the program memory 104 (13 bit). Decision circuitry 112 may determine if any of the first 5 bits of the active PC 120 address are a binary “1”. This process may enable decision circuitry 112 to determine if the active PC address 120 is for instructions in the first partition 106 or the second partition 108. In other words, decision circuitry 112 may determine if the active PC address 120 is greater than or less than the address defined by K. If all of the first 5 bits are binary “0” this may indicate that the active PC address 120 is for instructions with an address less than K and is therefore in the first partition 106, and decision circuitry 112 may truncate the first 4 bits of the active PC address 120 to form a 13 bit address (e.g., address 122) to fetch instructions from the first partition 106 of program memory 104.

However, and as stated in this example, the first five bits the active PC 120 include at least one binary “1” (e.g., 1_{—}0111). This may indicate that the active PC 120 of this example is addressing instructions in the second partition 108. In this case, decision circuitry 112 may forward the active PC address 120 to decoder circuitry 114. Decoder circuitry 114, in turn, may generate address 124, as depicted in FIG. 3. To generate address 124, in this example, decoder circuitry 114 may truncate the first 8 bits of address 120, the remaining 9 bits (e.g., bits 0-8) of the active PC address 120 may form the offset 306 of address 124. In this example, the offset is 0_{—}1111_{—}0001. Decoder circuitry 114 may then concatenate (and/or add) the thread number bits (304) to the offset for bits 9, 10 and 11. In this example, the thread number is 5, represented by binary 101. Decoder circuitry 114 may also generate a base bit (302). In this example, the base bit is a binary “1”, which may operate to place the address into the second partition 108. Accordingly, in this example, the resulting address 124 generated by decoder circuitry 114 is 1_{—}1010_{—}1111_{—}0001. The MSB of this address may operate to address the second partition 108 (e.g., the memory space greater than or equal to K), the next three MSBs of this address may address a particular thread's segment (in this example, Thread 5) and the remaining bits specify a specific location within this segment.

Of course, the foregoing example is provided to aid in understanding of the operative features of access circuitry 110, and it is not intended to limit the present disclosure to the aforementioned assumptions. It is to be understood that other values for K, the active PC address size, the size of the program memory 104, the relative sizes of the first partition 106, the second partition 108 and each segment in the second partition, as well as the size and address space of larger memory 202 are equally contemplated herein. Moreover, K may be selected to enable quicker decision processing. For example, whole number values of K (e.g., K=4k) may require less processing operations and may therefore enhance overall operations. However, as stated, any value of K is equally contemplated herein. Also, while the foregoing assumes that the first partition is less than K and the second partition is greater than or equal to K, in alternative embodiments the specific address of K could be included in either the first or second partition, in which case matching operations described herein may also determine the address is less than or equal to K or greater than K.

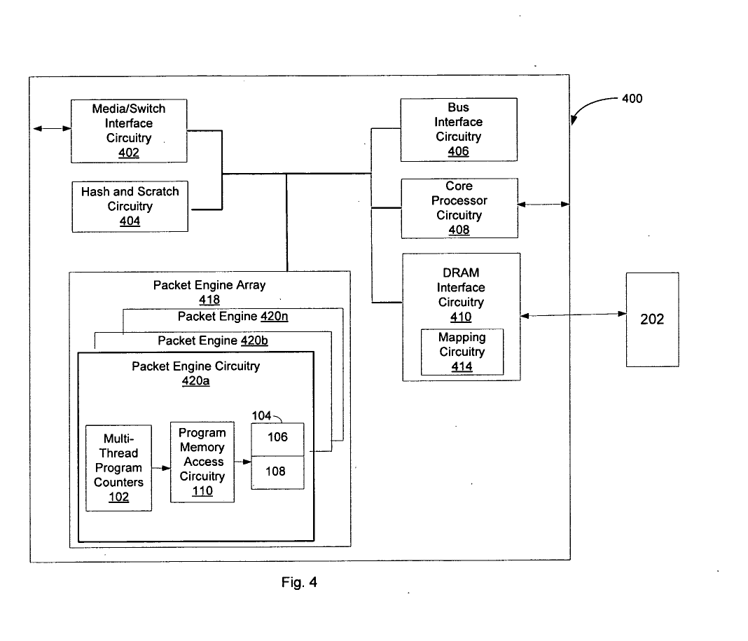

The embodiments of FIGS. 1-3 may be implemented in a variety of multi-threaded processing environments. For example, FIG. 4 is a diagram illustrating one exemplary integrated circuit embodiment 400 in which the operative elements of FIG. 1 may form part of an integrated circuit (IC) 400. “Integrated circuit”, as used in any embodiment herein, means a semiconductor device and/or microelectronic device, such as, for example, but not limited to, a semiconductor integrated circuit chip. The IC 400 of this embodiment may include features of an Intel® Internet eXchange network processor (IXP). However, the IXP network processor is only provided as an example, and the operative circuitry described herein may be used in other network processor designs and/or other multi-threaded integrated circuits.

The IC 400 may include media/switch interface circuitry 402 (e.g., a CSIX interface) capable of sending and receiving data to and from devices connected to the integrated circuit such as physical or link layer devices, a switch fabric, or other processors or circuitry. The IC 400 may also include hash and scratch circuitry 404 that may execute, for example, polynomial division (e.g., 48-bit, 64-bit, 128-bit, etc.), which may be used during some packet processing operations. The IC 400 may also include bus interface circuitry 406 (e.g., a peripheral component interconnect (PCI) interface) for communicating with another processor such as a microprocessor (e.g. Intel Pentium®, etc.) or to provide an interface to an external device such as a public-key cryptosystem (e.g., a public-key accelerator) to transfer data to and from the IC 400 or external memory. The IC may also include core processor circuitry 408. In this embodiment, core processor circuitry 408 may comprise circuitry that may be compatible and/or in compliance with the Intel® XScale™ Core micro-architecture described in “Intel® XScale™ Core Developers Manual,” published December 2000 by the Assignee of the subject application. Of course, core processor circuitry 408 may comprise other types of processor core circuitry without departing from this embodiment. Core processor circuitry 408 may perform “control plane” tasks and management tasks (e.g., look-up table maintenance, etc.). Alternatively or additionally, core processor circuitry 408 may perform “data plane” tasks (which may be typically performed by the packet engines included in the packet engine array 418, described below) and may provide additional packet processing threads.

Integrated circuit 400 may also include a packet engine array 418. The packet engine array may include a plurality of packet engines 420a, 420b, . . . , 420n. Each packet engine 420a, 420b, . . . , 420n may provide multi-threading capability for executing instructions from an instruction set, such as a reduced instruction set computing (RISC) architecture. Each packet engine in the array 218 may be capable of executing processes such as packet verifying, packet classifying, packet forwarding, and so forth, while leaving more complicated processing to the core processor circuitry 408. Each packet engine in the array 418 may include e.g., eight threads that interleave instructions, meaning that as one thread is active (executing instructions), other threads may retrieve instructions for later execution. Of course, one or more packet engines may utilize a greater or fewer number of threads without departing from this embodiment. The packet engines may communicate among each other, for example, by using neighbor registers in communication with an adjacent engine or engines or by using shared memory space.

In this embodiment, at least one packet engine, for example packet engine 420a, may include the operative circuitry of FIG. 1, for example, multi-thread program counters 102 and program memory 104. In this embodiment, the program memory may be a control store type memory to store instructions for the plurality of threads. Memory 104 may be partitioned into a first partition 106 and a second partition 108, and the second partition may include a plurality of thread-specific memory segments, as described above with reference to FIG. 1. Packet engine 420a may also include program memory access circuitry 110 as described above.

In this embodiment, the larger memory 202 may comprise an external memory coupled to the IC (e.g., external DRAM). Integrated circuit 400 may also include DRAM interface circuitry 410. DRAM interface circuitry 410 may control read/write access to external DRAM 202. As stated, instructions (executed by one or more threads associated with a packet engine) may be stored in DRAM 202. When new instructions are requested by a thread (for example, when a branch occurs during processing), packet engine 420a may issue an instruction to DRAM interface circuitry 410 to copy the instructions into the control store memory 104. To that end, DRAM interface circuitry 410 may include mapping circuitry 414 that may be capable of mapping a DRAM address associated with the requested instruction into an address in the control store memory 104. Referring briefly again to FIG. 2 and with continued reference to FIG. 4, mapping circuitry 414 may map instructions from the first portion 204 of memory 202 into the first partition 106 of memory 104. As stated previously, these instructions may be mapped and copied directly between the first portion 204 of memory 202 into the first partition 106 of memory 104. Likewise, mapping circuitry 414 may map instructions from the second portion 206 of memory 202 into a given segment of the second partition 108 of memory 104, based on, for example, the value of K and the thread number making the copy request.

Memory 202 may comprise one or more of the following types of memory: semiconductor firmware memory, programmable memory, non-volatile memory, read only memory, electrically programmable memory, static random access memory (e.g., SRAM), flash memory, dynamic random access memory (e.g., DRAM), magnetic disk memory, and/or optical disk memory. Either additionally or alternatively, memory 202 may comprise other and/or later-developed types of computer-readable memory. Machine readable firmware program instructions may be stored in memory 202, and/or other memory. These instructions may be accessed and executed by the integrated circuit 400. When executed by the integrated circuit 400, these instructions may result in the integrated circuit 400 performing the operations described herein as being performed by the integrated circuit, for example, operations described above with reference to FIGS. 1-7.

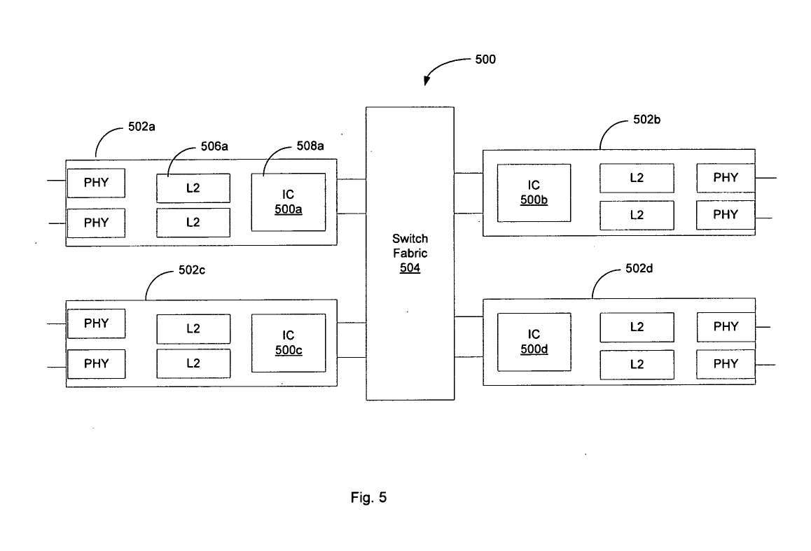

FIG. 5 depicts one exemplary system embodiment 500. This embodiment may include a collection of line cards 502a, 502b, 502c and 502d (“blades”) interconnected by a switch fabric 504 (e.g., a crossbar or shared memory switch fabric). The switch fabric 504, for example, may conform to CSIX or other fabric technologies such as HyperTransport, Infiniband, PCI-X, Packet-Over-SONET, RapidIO, and Utopia. Individual line cards (e.g., 502a) may include one or more physical layer (PHY) devices 508a (e.g., optic, wire, and wireless PHYs) that handle communication over network connections. The PHYs may translate between the physical signals carried by different network mediums and the bits (e.g., “0”-s and “1”-s) used by digital systems. The line cards may also include framer devices 506a (e.g., Ethernet, Synchronous Optic Network (SONET), High-Level Data Link (HDLC) framers or other “layer 2” devices) that can perform operations on frames such as error detection and/or correction. The line cards shown may also include one or more integrated circuits, e.g., 400a, which may include network processors, and may be embodied as integrated circuit packages (e.g., ASICs). In addition to the operations described above with reference to integrated circuit 400, in this embodiment integrated circuit 400a may also perform packet processing operations for packets received via the PHY(s) 408a and direct the packets, via the switch fabric 504, to a line card providing the selected egress interface. Potentially, the integrated circuit 400a may perform “layer 2” duties instead of the framer devices 506a.

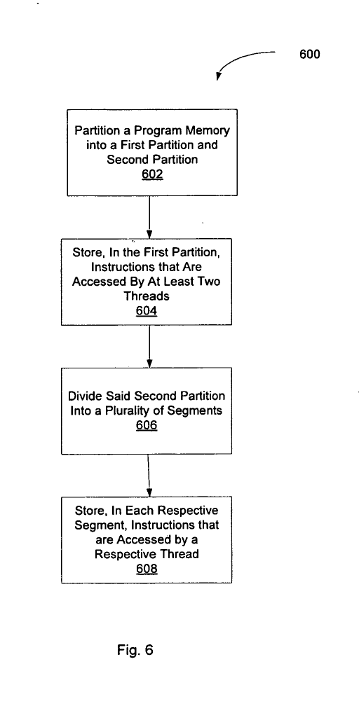

FIG. 6 depicts a flowchart 600 of operations according to one embodiment. Operations may include partitioning a program memory into a first partition and a second partition 602; Operations may further include storing, in the first partition, instructions that are accessed by at least one thread 604. Operations may also include dividing the second partition into a plurality of segments 606. Operations may additionally include storing, in each respective segment, instructions that are accessed by a respective thread 608.

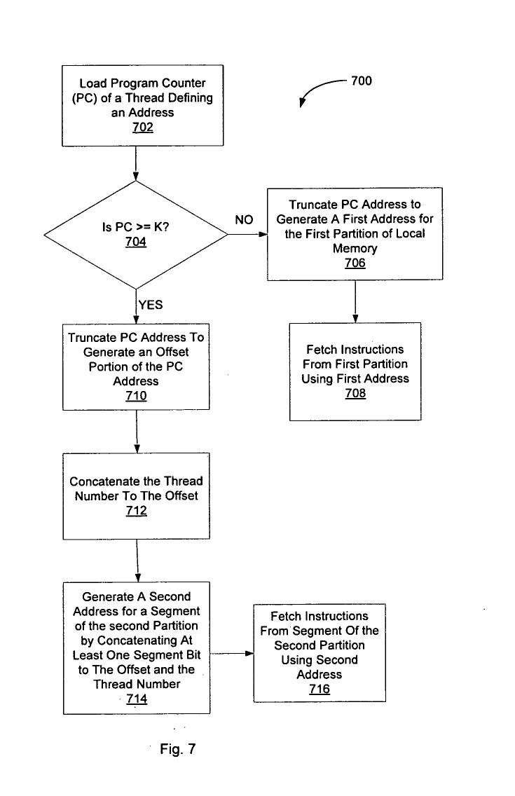

FIG. 7 depicts a flowchart 700 of operations according to another embodiment. Operations according to this embodiment may include loading a program counter (PC) of a thread, the PC defining an address 702. Operations may also include comparing the PC to the K of the program memory 704. K may include, for example, an address that defines the boundary between the first and second partitions of the program memory. Alternatively, K could be a fraction representing the size of the first partition relative to the second partition. If the PC is less than the value of K, operations according to this embodiment may also include truncating the PC address to generate a first address for the first partition of the program memory 706. Operations may also include fetching instructions from the first partition using the first address 708. If the PC is greater than or equal to the value of K, operations according to this embodiment may also include truncating the PC address to generate an offset portion of the PC address 710. Operations may further include concatenating the thread number to the offset 712. Operations may additionally include generating a second address for a segment of the second partition by concatenating at least one offset bit to the remainder and the thread number 714. Operations may also include fetching instructions from a segment of the second partition using the second address 708.

As used in any embodiment described herein, “circuitry” may comprise, for example, singly or in any combination, hardwired circuitry, programmable circuitry, state machine circuitry, and/or firmware that stores instructions executed by programmable circuitry. It should be understood at the outset that any of the operative components described in any embodiment herein may also be implemented in software, firmware, hardwired circuitry and/or any combination thereof. A “network device”, as used in any embodiment herein, may comprise for example, a switch, a router, a hub, and/or a computer node element configured to process data packets, a plurality of line cards connected to a switch fabric (e.g., a system of network/telecommunications enabled devices) and/or other similar device.

Additionally, the operative circuitry of FIG. 1 may be integrated within one or more integrated circuits of a computer node element, for example, integrated into a host processor (which may comprise, for example, an Intel® Pentium® microprocessor and/or an Intel® Pentium® D dual core processor and/or other processor that is commercially available from the Assignee of the subject application) and/or chipset processor and/or application specific integrated circuit (ASIC) and/or other integrated circuit. In still other embodiments, the operative circuitry provided herein may be utilized, for example, in a caching system and/or in any system, processor, integrated circuit or methodology that may use multiple threads to execute instructions.

Accordingly, at least one embodiment described herein may provide an integrated circuit (IC) configured to execute instructions using a plurality of threads. The IC may include a program memory for storing the instructions. The IC may be further configured to partition the program memory into a first partition and a second partition. The IC may also be configured to store instructions in the first partition and to provide access to the first partition to at least two threads. The IC may be further configured to divide the second partition into a plurality of segments, store instructions in each respective segment corresponding to each respective thread, and provide access to each respective segment for each respective thread.

The terms and expressions which have been employed herein are used as terms of description and not of limitation, and there is no intention, in the use of such terms and expressions, of excluding any equivalents of the features shown and described (or portions thereof, and it is recognized that various modifications are possible within the scope of the claims. Accordingly, the claims are intended to cover all such equivalents.

What is claimed is:

1. An apparatus, comprising:
an integrated circuit (IC) configured to execute instructions using a plurality of threads; said IC comprising a program memory for storing the instructions, said IC is further configured to partition said program memory into a first partition and a second partition, said IC is further configured to store instructions in said first partition and to provide access to said first partition to at least one said thread, said IC is further configured to divide said second partition into a plurality of segments, store instructions in each respective segment corresponding to each respective thread, and provide access to each respective segment for each respective thread.

2. The apparatus of claim 1, wherein:
each thread accesses the instructions stored in program memory using a program counter defining an address in another memory having a larger address space than said program memory, said IC is further configured to generate a first address to address instructions stored in the first partition if said program counter defines an address corresponding to said first partition, and a second address if said program counter defines an address in said second partition.

3. The apparatus of claim 2, wherein:
said IC is further configured to generate said first address by truncating said program counter to the appropriate number of bits to address said first partition of said program memory.

4. The apparatus of claim 2, wherein:
said IC is further configured to generate said second address by the following operations:
truncating the program counter to generate an offset having a defined number of bits;
concatenating the thread number corresponding to the program counter; and
concatenating at least one segment bit to said remainder and said thread number.

5. The apparatus of claim 1, wherein:
said IC is further configured to map a first set of said instructions from another memory into said first partition, said other memory having a larger memory space than said program memory, said IC is further configured to map, in response to a copy request by at least one thread to copy instructions from the external memory into the program memory, a second set of said instructions from the external memory into at least one segment of said second partition based on, at least in part, the thread, among the plurality of threads, generating said copy request.

6. The apparatus of claim 1, wherein:
said IC is further configured to store primary branch instructions in said first partition and at least one secondary branch instruction in at least one segment of said second partition.

7. The apparatus of claim 1, wherein:
said IC further comprising program memory access circuitry configured to provide a given thread access to the first partition and/or a segment of the second partition based on, at least in part, the address of an instruction being accessed by the given thread that corresponds to an address in another memory and the thread number of the given thread.

8. A method, comprising:
partitioning a memory into a first partition and a second partition;
storing instructions in said first partition;
providing access, to at least one thread among a plurality of threads, to said instructions in said first partition;
dividing said second partition into a plurality of segments;
storing instructions in each respective segment corresponding to each respective thread; and
providing access to each respective segment for each respective thread.

9. The method of claim 8, further comprising:
accessing the instructions stored in program memory using a program counter defining an address of another memory having a larger address space than said memory;
generating a first address to address instructions stored in the first partition if said program counter defines an address corresponding to said first partition; and
generating a second address if said program counter defines an address in said second partition.

10. The method of claim 9, further comprising:
generating said first address by truncating said program counter to the appropriate number of bits to address said first partition of said memory.

11. The method of claim 8, further comprising:
generating said second address by the following operations:
truncating the program counter to generate an offset having a defined number of bits;
concatenating the thread number corresponding to the program counter; and
concatenating at least one segment bit to said offset and said thread number.

12. The method of claim 8, further comprising:
mapping a first set of said instructions from another memory having a larger memory space than memory; and
mapping, in response to a copy request by at least one thread to copy instructions from the other memory into the memory, a second set of said instructions from the other memory into at least one segment of said second partition based on, at least in part, the thread, among the plurality of threads, generating said copy request.

13. The method of claim 8, further comprising:
storing primary branch instructions in said first partition and at least one secondary branch instruction in at least on segment of said second partition.

14. The method of claim 8, further comprising:
providing a given thread access to the first partition and/or a segment of the second partition based on, at least in part, the address of the given thread that corresponds to an address in another memory and the thread number of the given thread.

15. An article comprising a storage medium having stored thereon instructions that when executed by a machine result in the following:
partitioning a memory into a first partition and a second partition;
storing instructions in said first partition;
providing access, to at least one thread among a plurality of threads, to said instructions in said first partition;
dividing said second partition into a plurality of segments;
storing instructions in each respective segment corresponding to each respective thread; and
providing access to each respective segment for each respective thread.

16. The article of claim 15, wherein said instructions that when executed by said machine results in the following additional operations:
accessing the instructions stored in program memory using a program counter defining an address of other memory, said external memory having a larger address space than said memory;
generating a first address to address instructions stored in the first partition if said program counter defines an address corresponding to said first partition; and
generating a second address if said program counter defines an address in said second partition.

17. The article of claim 16, wherein said instructions that when executed by said machine results in the following additional operations:
generating said first address by truncating said program counter to the appropriate number of bits to address said first partition of said memory.

18. The article of claim 16, wherein said instructions that when executed by said machine result in the following additional operations:
generating said second address by the following operations:
truncating the program counter to generate an offset having a defined number of bits;
concatenating the thread number corresponding to the program counter; and
concatenating at least one segment bit to said offset and said thread number.

19. The article of claim 15, wherein said instructions that when executed by said machine result in the following additional operations:
mapping a first set of said instructions from another memory having a larger memory space than memory; and
mapping, in response to a copy request by at least one thread to copy instructions from the other memory into the memory, a second set of said instructions from the other memory into at least one segment of said second partition based on, at least in part, the thread, among the plurality of threads, generating said copy request.

20. The article of claim 15, wherein said instructions that when executed by said machine result in the following additional operations:
storing primary branch instructions in said first partition and at least one secondary branch instruction in at least on segment of said second partition.

21. The article of claim 15, wherein said instructions that when executed by said machine result in the following additional operations:
providing a given thread access to the first partition and/or a segment of the second partition based on, at least in part, the address of the given thread that corresponds to an address in other memory and the thread number of the given thread.

22. A system to process packets received over a network, the system comprising:
a plurality of line cards and a switch fabric interconnecting said plurality of line cards, at least one line card comprising:
at least one physical layer component (PHY); and
an integrated circuit (IC) comprising a plurality of packet engines, each said packet engine is configured to execute instructions using a plurality of threads; said IC comprising a program memory for storing the instructions, said IC is further configured to partition said program memory into a first partition and a second partition, said IC is further configured to store instructions in said first partition and to provide access to said first partition to at least one said thread, said IC is further configured to divide said second partition into a plurality of segments, store instructions in each respective segment corresponding to each respective thread, and provide access to each respective segment for each respective thread.

23. The system of claim 22, wherein:
each thread accesses the instructions stored in program memory using a program counter defining an address in another memory having a larger address space than said program memory, said IC is further configured to generate a first address to address instructions stored in the first partition if said program counter defines an address corresponding to said first partition, and a second address if said program counter defines an address in said second partition.

24. The system of claim 23, wherein:
said IC is further configured to generate said first address by truncating said program counter to the appropriate number of bits to address said first partition of said program memory.

25. The system of claim 23, wherein:
said IC is further configured to generate said second address by the following operations:
truncating the program counter to generate an offset having a defined number of bits;
concatenating the thread number corresponding to the program counter; and
concatenating at least one segment bit to said offset and said thread number.

26. The system of claim 22, wherein:
said IC is further configured to map a first set of said instructions from another memory having a larger memory space than said program memory, said IC is further configured to map, in response to a copy request by at least one thread to copy instructions from the external memory into the program memory, a second set of said instructions from the external memory into at least one segment of said second partition based on, at least in part, the thread, among the plurality of threads, generating said copy request.

27. The system of claim 22, wherein:
said IC is further configured to store primary branch instructions in said first partition and at least one secondary branch instruction in at least on segment of said second partition.

28. The system of claim 22, wherein:
said IC further comprising program memory access circuitry configured to provide a given thread access to the first partition and/or a segment of the second partition based on, at least in part, the address of the given thread that corresponds to an address in another memory and the thread number of the given thread.
